(19) United States
(12) Patent Application Publication
(10) Pub. No.: US 2003/0140738 A1
(43) Pub. Date: Jul. 31, 2003

(54) Protective wrench socket

(76) Inventor: Russell A. Wallace, Lynville, IN (US)

Correspondence Address: BOWERS HARRISON LLP, GARY K. PRICE, ESP., 25 RIVERSIDE DRIVE, PO BOX 1287, EVANSVILLE, IN, 47706-1287, US

(21) Appl. No.: 10/055,328

(22) Filed: Jan. 25, 2002

(51) Int. Cl. B25B 13/06

(52) U.S. Cl. 81/121.1

(57) ABSTRACT

A wrench socket for use with a conventional ratchet wrench system to attach or remove a nut or bolt on a surface area. Such wrench socket comprising an elongated hollow cylinder having a first end portion, a recessed end portion having a shoulder, a nut or bolt engaging end in communication with the recessed end portion, a hexagonally shaped socket opening sized to receive said nut or bolt, and disposed midway in the nut or bolt engaging end, and an outer protective sleeve pressed on the recessed end portion, so that when attaching or removing the nut or bolt with the socket wrench system, should the wrench socket slip off the nut or bolt, the outer protective sleeve surrounding the socket opening will contact the surface area.

### CROSS REFERENCES TO RELATED APPLICATIONS

None

### STATEMENT AS TO RIGHTS TO INVENTIONS MADE UNDER FEDERALLY SPONSORED RESEARCH AND DEVELOPMENT

Not Applicable

### BACKGROUND OF THE INVENTION

1. Field of the Invention

This invention relates to wrench sockets used to attach and remove nuts or bolts, particularly on a finished surface, and more specifically a wrench socket having a protection surface portion that prevents the exterior metal surface of the wrench socket to make contact with the finished surface.

2. Background of the Invention

Conventional wrench sockets used to attach and remove various sized nuts or bolts are known in the art. Such wrench sockets, for strength and structural integrity, are made of a hard metal material.

A common problem with using these conventional wrench sockets to attach or remove nuts or bolts on a finished surface, is that when applying leverage to the wrench system, the socket wrench often slips off the nut or bolt causing the exterior metal surface of the wrench socket to come in contact with the finished surface. The contact of the exterior metal surface of the wrench socket to the finished surface will likely cause nicks and chips in the finished surface. As a result, it becomes necessary for that portion of the damaged finished surface to be sanded down and re-finished. This process is often difficult, inconvenient, and costly.

As will be seen from the subsequent description, the preferred embodiment of the present invention overcome these and other shortcomings of prior art.

### SUMMARY OF THE INVENTION

The present invention comprises a wrench socket having an outer protective sleeve portion for use with a conventional wrench system or impact wrench to remove nuts or bolts.

The invention is designed to prevent the exterior metal surface of the wrench socket to make contact with the finished surface during use. The preferred embodiment includes a wrench socket used in connection with a socket wrench system, said wrench socket includes an elongated body having a first end portion and a recessed end portion and an outer protective sleeve that is pressed onto the recessed end portion of the wrench socket. The recessed end portion including a hexagon socket sized to fit a nut or bolt, so that when attaching or removing the nut or bolt with the socket wrench system, should the wrench socket slip off the nut or bolt, the outer protective sleeve surrounding the recessed end portion and the hexagon socket of the socket wrench will contact the finished surface not the exterior metal surface of the wrench socket, preventing the finished surface from becoming nicked or chipped.

### BRIEF DESCRIPTION OF THE DRAWINGS

FIG. 1 is a perspective view of a preferred embodiment of the present invention, namely a protective wrench socket.

FIG. 2 is an exploded perspective view of the three (3) components of the wrench socket of FIG. 1, namely, a first end portion, a recessed end portion and an outer protective sleeve.

FIG. 3 illustrates a sectional perspective view of the outer protective sleeve of the wrench socket of FIG. 2.

### DESCRIPTION OF THE PREFERRED EMBODIMENTS

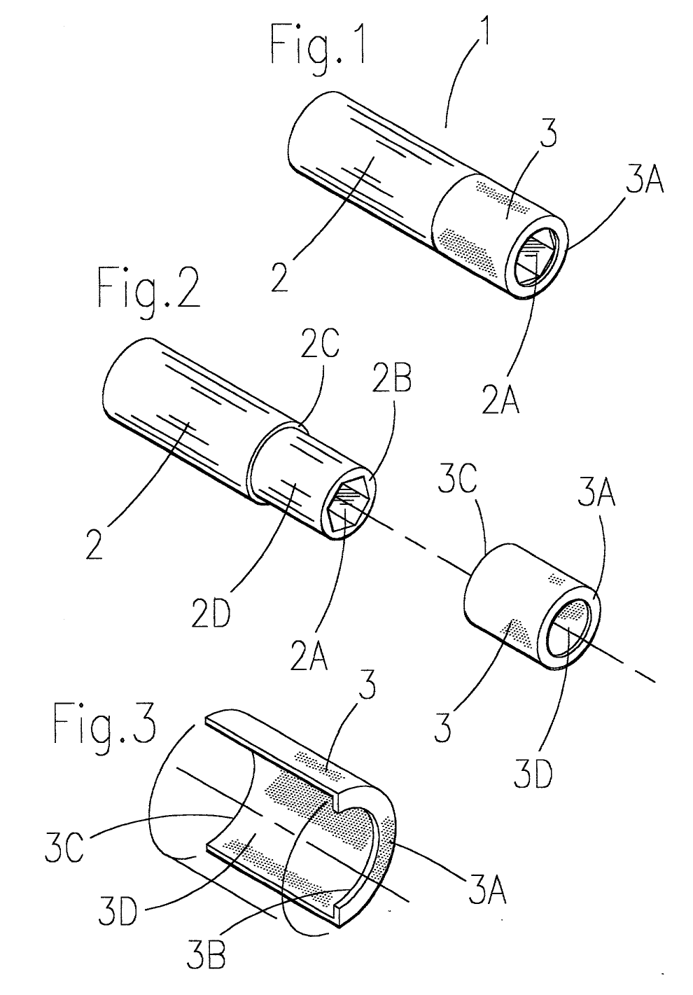

FIG. 1 illustrates a preferred embodiment of a protective wrench socket 1 made in accordance with the present invention. The wrench socket 1 of the present invention is for use with a conventional socket wrench system or impact wrench system to remove a nut or bolt from a surface area. Internal details of the conventional socket wrench system are not shown in the drawings since the ratchet system used with the wrench socket 1 is of conventional, commercially-available wrenches.

As shown in FIG. 2, the wrench socket 1 has an elongated body and includes a first end portion 2, a recessed end portion 2D, and an outer protective sleeve 3. The first end portion 2, the recessed end portion 2D, and the outer protective sleeve 3 have a generally cylindrical configuration. Said recessed end portion 2D having a horizontally positioned interior bore 2F. The horizontally positioned interior bore 2F extends through the entire diameter of the body of the wrench socket 1. As will be discussed, the outer protective sleeve 3 is pressed onto the recessed end portion 2D of the wrench socket 1.

Further referring to FIG. 2, the wrench socket 1 includes a nut or bolt engaging end 2B, which said nut or bolt engaging end 2B is in communication with the recessed end portion 2D. The nut or bolt engaging end 2B having an opening to the interior bore 2F of the recessed end portion 2D and defining a hexagon socket 2A, said hexagon socket 2A positioned midway in the nut or bolt engaging end 2B of the wrench socket 1, and sized to fit said nut or bolt (not shown). The hexagon socket 2A sized to fit said nut or bolt is hexagonally shaped. Said wrench socket 1 having a second end 2E opposite the first end 2B. Said second end 2E including an opening (not shown) sized and shaped to receive the conventional socket wrench.

As best shown in FIG. 2, the circumference of the recessed end portion 2D is slightly less than the circumference of the first end portion 2. An important feature in maintaining the wrench socket's 1 structural integrity, is that the circumference of the recessed end portion 2D is approximately 0.008-0.010 inches less than the circumference of the first end portion 2. As a result, the recessed end portion 2D extends from the nut or bolt engaging end 2B of the wrench socket 1 and terminates at a shoulder 2C. The first end portion 2 extends from the shoulder 2C and terminates at the second end 2E. In a further desirable embodiment of the present invention, the length of the recessed end portion 2D is approximately one-third the total length of the wrench socket 1.

The outer protective sleeve 3 is substantially as long as the recessed end portion 2D. The outer protective sleeve 3 is pressed onto the recessed end portion 2D of the socket 1. The outer protective sleeve 3 includes a sleeve first end 3A, a sleeve second end 3C and an interior sleeve bore 3D that extends horizontally through the entire diameter of the outer protective sleeve 3 from the midway of the sleeve first end 3A to the midway of the sleeve second end 3C. The interior sleeve bore 3D sized to tightly fit over the recessed end portion 2D of the wrench socket 1.

When the outer protective sleeve 3 is pressed onto the recessed end portion 2D into a single unit, the second end 3C of the outer protective sleeve 3 engages the shoulder 2C of the wrench socket 1, so that the first end portion 2 and the outer protective sleeve 3 are continuously circumferentially aligned to each other, as shown in FIG. 1.

As further shown in FIG. 1, once the outer protective sleeve 3 is pressed onto the recessed end portion 2D, the surface area of the sleeve first end 3A covers any metal surface area of the nut or bolt engaging end 2B of the wrench socket 1.

FIG. 3 illustrates a sectional perspective view of the outer protective sleeve 3. Said outer protective sleeve further includes an interior side wall 3D which forms the said interior sleeve bore 3D. When the outer protective sleeve 3 is pressed onto the recessed end portion 2D, the interior side wall 3D is in pressed communication with the outer surface of the recessed end portion 2D. The outer protective sleeve 3 and the recessed end portion 2D forming a single unit.

The wrench socket 1 is generally made of a hard metal material. The outer protective sleeve 3 is made of a durable nylon material.

In use, the hexagon socket 2A of the wrench socket 1 is slid onto the nut or bolt to be attached or removed. Said nut or bolt being surrounded by a surface area. Once the wrench socket 1 is in place over the nut or bolt, the user then either attaches or removes the bolt using a conventional socket wrench system. When tightening or first removing the nut or bolt, the user often applies force in order to tighten or loosen. When applying such force during the tightening or loosening process, the wrench socket 1 often slips off the nut or bolt, causing the wrench socket 1 to come in contact with the said outer surface area. Should the wrench socket 1 of the present invention slip off the nut or bolt, the outer protective sleeve 3 of the wrench socket 1 that surrounds the hexagon socket 2A of the wrench socket 1 will contact the surface area. As a result of the outer protective sleeve 3 of the wrench socket 1 coming in contact with the outer surface rather than the metal surface of the wrench socket 1, the surface area will avoid being nicked or chipped by such contact.

Although the description above contains some specificities, these should not be construed as limiting the scope of the invention but as merely providing illustrations of a preferred embodiment of this invention.

Thus the scope of the invention should be determined by the appended claims in the formal application and their legal equivalence, rather than by the examples given.

I claim:

1. A wrench socket for use with a conventional ratchet wrench system to attach or remove a nut or bolt on a surface area, said wrench socket comprising:
a hollow cylinder having a first end portion, and a recessed end portion having a shoulder, a nut or bolt engaging end in communication with the recessed end portion, and a hexagonally shaped socket opening sized to receive said nut or bolt, said socket opening disposed midway in the nut or bolt engaging end, and
an outer protective sleeve pressed on the recessed end portion.

2. A wrench socket as recited in claim 1, wherein the circumference of the recessed end portion is approximately 0.008-0.010 inches less than the circumference of the first end portion.

3. A wrench socket as recited in claim 1, wherein the length of the recessed end portion is approximately one-third the total length of the hollow cylinder.

4. A wrench socket as recited in claim, wherein the outer protective sleeve is made of a durable nylon material.
